(19) United States
(12) Patent Application Publication
(10) Pub. No.: US 2003/0227870 A1
(43) Pub. Date: Dec. 11, 2003

(54) Method and system for automated voice quality statistics gathering

(76) Inventors: Clinton Allen Wagner, Marion, IA (US); Lev B. Sofman, Plano, TX (US)

Correspondence Address: WORLDCOM, INC., TECHNOLOGY LAW DEPARTMENT, 1133 19TH STREET NW, WASHINGTON, DC, 20036, US

(21) Appl. No.: 10/423,194

(22) Filed: Apr. 25, 2003

Related U.S. Application Data
(60) Provisional application No. 60/385,481, filed on Jun. 3, 2002.

(51) Int. Cl. H04L 1/00

(52) U.S. Cl. 370/229; 370/252

(57) ABSTRACT

A method of monitoring the quality of a communication system is described. A first telephone user initiates a telephone call with a second telephone user. The service provider connects the first telephone user with the second telephone user so that the telephone conversation can be conducted. Upon completion of the telephone conversation, a quality survey is automatically conducted with at least one of, and preferably both, of the telephone users.

This application claims the benefit of U.S. Provisional Application No. 60/385,481, filed on Jun. 3, 2002, entitled “Method and System for Automated Voice Quality Statistics Gathering,” which application is hereby incorporated herein by reference.

### CROSS-REFERENCE TO RELATED APPLICATIONS

The following U.S. patents and/or commonly assigned patent applications are hereby incorporated herein by reference:

| Patent or | | | Attorney |
|---|---|---|---|
| Serial No. | Filing Date | Issue Date | Docket No. |
| 08/751,023 | Nov. 18, 1996 | | VON-96-001 |
| 08/798,350 | Feb. 10, 1997 | | VON-97-004 |
| 6,370,120 | Dec. 24, 1998 | Apr. 09, 2002 | RIC-98-014 |
| 09/778,186 | Feb. 07, 2001 | | RIC-98-014P1 |
| 09/866,770 | May 30, 2001 | | RIC-98-014P2 |

### FIELD OF THE INVENTION

This invention relates generally to telecommunications and more specifically to method and system for automated voice quality statistics gathering.

### BACKGROUND OF THE INVENTION

Telephone connections have always been subject to impairments in the form of noise, attenuation, distortion, crosstalk, and echo. Such impairments are particularly common to analog portions of the connection, such as along subscriber loops and within frequency domain multiplexing equipment. Digital transmission alleviates many of these problems but introduces quantization noise or glitches. Even with perfect digital transmission applied for long-haul connections, a typical telephone connection includes many analog components, such as hybrids, where impairments can occur.

A poor connection or a malfunctioning piece of equipment can produce conditions that a telephone customer will find objectionable or intolerable, so that the connection is deemed to be of very poor quality. When there is a high incidence of such poor connections, customers may complain to the service provider or regulatory authorities, or simply change long distance carriers. Perceived quality of telephone connections is therefore a major factor affecting the reputation and marketability of long distance telephone services.

To guard against poor quality, telephone service providers have developed methods to take objective quality measurements upon a line, a piece of equipment, or even an end-to-end telephone connection. These measurements can help the service provider detect and gauge impairments, pinpoint weak elements and correct deficiencies that degrade user perception of quality.

Another way to measure quality is to perform subjective tests where people listen to recorded messages or live messages and rate the quality of what they heard. In existing methods for subjective voice quality tests, the tester's participation is schedule in advance. This person is then asked to evaluate pre-recorded messages. The results of this evaluation can be used to rate system quality.

For example, each tester may be asked to provide an opinion score, which is an overall rating of the circuit quality on a numerical scale. Each tester may also determine whether the overall effect of the impairments was to render the connection: unusable (U; rendering the channel entirely unusable), difficult (D; causing enough difficulty to require adaptation by the speaker and listener), irritating (I; disturbing but not requiring adaptation by the speaker and listener), noticeable (N; minor enough to be ignored), or unnoticeable (O; no effect on quality). The percentage of calls or connections that elicit any one of the first three responses (unusable, difficult, or irritating) is called the P(UDI). The P(UDI) is of particular interest to service providers as a meter of customer satisfaction because it has been shown that overall satisfaction decreases as P(UDI) increases, regardless of average opinion score.

Inefficiencies exist in known testing scenarios where testers evaluate pre-prepared messages. These kinds of tests tend to be expensive and require significant organizational coordination and effort. If interactive tests are to be performed, there is even more need for organizational efforts and expenses to schedule both parties participation. Due to these factors, it is difficult to gather statistically significant amounts of data.

### SUMMARY OF THE INVENTION

In one aspect, the present invention provides a way to automatically monitor and even enhance the quality of a communications network. This monitoring can be performed automatically and generate statistically significant amounts of data.

The present invention includes a number of aspects. The preferred system includes test monitor units (TMU) that could be installed, for example, in some particular PBXs (in test domain) and a central processor. All TMU's are preferably connected with the central processor by conventional IP links.

In the preferred embodiment, each TMU analyzes all outgoing calls from a given PBX. If the termination PBX belongs to the test domain then a monitoring procedure can be initiated. In this procedure, the TMU on termination PBX is notified about the call. Preferably, the TMUs receive all set-up information (e.g., called party, call begin/termination points) from SS7 (circuit switched) and SIP (VoIP). In the case of comparison between alternative technologies (e.g., voice over Internet Protocol vs. circuit switched), the call is randomly routed through alternative media (e.g., circuit switched or packet switched networks). Call selection could be also based on monitoring all calls and selecting those calls that have a specific impairment or set of impairments. The selected calls can be rated to determine the impact of any impairment on the connection.

At the beginning of the call (e.g., when call is set up) and at the end of the call, TMUs on both sides send a voice message (e.g., call back) to calling parties. At the beginning of the call the message can inform users about the test. At the end of the call the message can solicit input relating to the quality of the call (e.g., on a 1 to 4 or 1 to 5 scale).

During the evaluation phase, the user typically answers three or four questions on voice quality (e.g., noise, distortion, echo, delay, etc.-). The user will typically answer the questions using the telephone keypad or through voice recognition. Optionally, at the end of the evaluation the user can be notified about network type used (e.g., circuit or packet switched).

The test results from both calling parties, together with general information such as the date, time of start and end of the call, type of alternative technology used in the call, could be sent from TMUs to the processor where it should be stored and processed. Independently, network congestion data (e.g., information on PBX trunk utilization, signal and noise level, etc.) could be gathered and stored at the processor. This information can be used for statistical analysis together with quality data mentioned above to correlate subjective voice quality data and objective factors, like network condition.

Aspects of the present invention can provide a number of advantages. The conduct of surveys is less expensive since surveys are automatically initiated by the system. As a result, there are less organizational efforts and it is easy to receive a statistically significant amount of test data. Further, this data tends to be more reliable, since it is “real life” data based on real conversations as opposed to pre-recorded test messages.

### BRIEF DESCRIPTION OF THE DRAWINGS

The above features of the present invention will be more clearly understood from consideration of the following descriptions in connection with accompanying drawings in which:

FIG. 1 illustrates a system that can utilize aspects of the present invention;

FIG. 2 provides a flow chart of a procedure of the present invention; and

FIG. 3 provides a block diagram of an exemplary test unit of the present invention.

### DETAILED DESCRIPTION OF ILLUSTRATIVE EMBODIMENTS

The making and use of the various embodiments are discussed below in detail. However, it should be appreciated that the present invention provides many applicable inventive concepts which can be embodied in a wide variety of specific contexts. The specific embodiments discussed are merely illustrative of specific ways to make and use the invention, and do not limit the scope of the invention.

In one aspect, the present invention provides a system and method to automatically generate and compile subjective quality analyses of voice calls. The data for the quality is analysis is gathered from users immediately following real-world telephone conversations. For example, in one embodiment, a user makes a telephone call, after which the respondent is instructed to answer a series of questions relating to the quality of the call.

As an example, various aspects of the present invention can be utilized in situations where new system components are being implemented. For example, many telecommunications networks are being modified to include packet switched portions, either in whole or in part. In the context of voice communication, Voice over Internet Protocol (VoIP) is being utilized for voice calls, often in conjunction with data and/or video.

Voice quality is an important factor for VoIP. Aspects of the present invention can be used to create an automated system of subjective quality measurements. One place where information can be gathered is to perform a comparison of VoIP and circuited switched voice quality. The present invention provides a number of advantages in this context.

A preferred embodiment system includes test monitor units (TMUs) that are installed in some particular PBXs and/or voice switches. The TMUs can be used to call back to one or both of the calling parties and prompt them to answer some questions about voice quality, e.g., using the telephone keypad. The test units will analyze voice quality for calls between PBXs and voice switches that belong to the test domain. Each test unit analyzes some (or all) outgoing calls from a given location, e.g., PBX.

A preferred embodiment system also includes a test data server. This device is preferably a central database that includes quality measurements from the TMUs, congestion measurements from the networks, and data from the subjective quality studies. All of this information can be used to analyze the quality of the network.

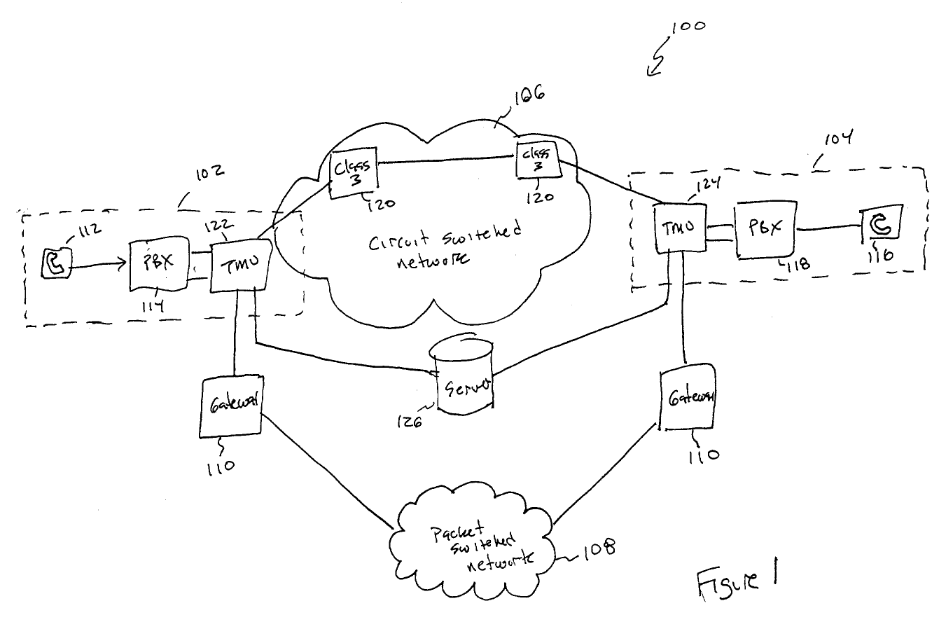

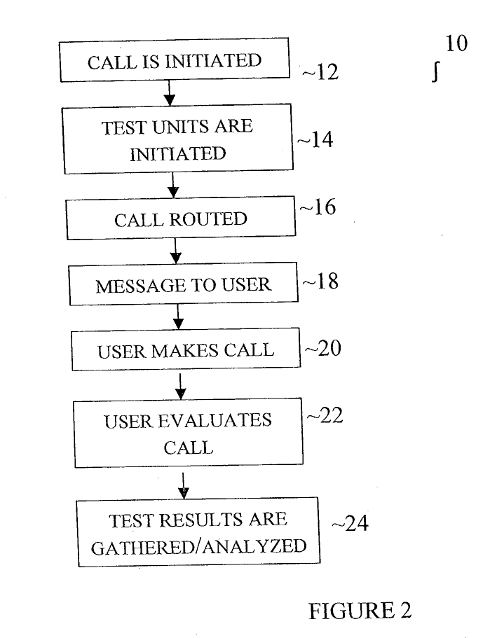

A system that utilizes the preferred embodiment will now be described with respect to FIG. 1. After the description of the system, a method of using the system will be described with respect to FIG. 2.

Referring now to FIG. 1, a telecommunications network 100 is illustrated. This simplified network includes two endpoints 102 and 104, where calls are originated and terminated. The illustrated network includes both conventional TDM (time division multiplexed) switched network 106 and packet switched network 108. As an example, the switched network portion 106 can the public switched telephone network (PSTN). The present invention, however, is equally applicable to use with proprietary equipment and private networks.

Packet-switched network 108, sometimes referred to as a converged network, typically combines various types of media such as voice calls, data and streams of video onto a single line. While many protocols can be utilized, most current networks carrying packet-switched voice use Internet Protocol (IP). All these different media are chopped into discrete blocks of data or packets. One example of an IP-based network is the public Internet. In this context, the “Internet” (uppercase “I”) or public Internet is used to connote the worldwide collection of interconnected networks that uses Internet Protocol (IP) to link a large number of physical networks into a single logical network. Physically, the Internet is a huge, global network spanning nearly 100 countries and comprising a great number of academic, commercial, government, and military networks.

Packet-switched network 18 could also comprise other IP-based networks as well as other communication networks. For example, packet-switched network 18 could comprise an internet that is not connected to the public Internet. In this context, an “internet” (lowercase “i”) is any collection of separate physical networks, interconnected by a common protocol, to form a single logical network. An internet would preferably, but not necessarily use Internet Protocol. An internet that is owned by a single entity is sometimes referred to as an intranet or virtual private network. Network 18 can comprise an intranet, which is or is not connected to the Internet.

The circuit switched portions 106 of the network are coupled to the packet switched portions 108 through gateway 110, two of which are shown. Gateway 110 is sometimes referred to as an internet telephony gateway (ITG). Gateway 110 converts the circuit switched telephone signals into packets that are compatible with packet-switched network 108, and vice versa. Gateway 110 has access to a directory (not shown) of addresses (e.g. IP addresses for an IP-based network). Utilizing this directory, gateway 110 addresses the packets to the appropriate exit gateway.

The network 100 illustrated in FIG. 1 shows one example of a very simplified network. In a real world system, the network could, and probably would be, much more complex. For the purpose of the evaluation system and method portions of the present invention, the network configuration is not material. For these purposes, what is important is that there is a network, or a portion of a network, that is to be evaluated.

In the example of FIG. 1, the originating user communicates with a telephone 112 that is coupled to a PBX 114. Similarly, the terminating user communicates with a telephone 116 that is coupled to a PBX 118. The PBX 114 and 118 are both optional. Further, communication devices other than land-line telephones are envisioned. For example, aspects of the present invention can be utilized with wireless telephones and with voice communications using computers, as but two examples.

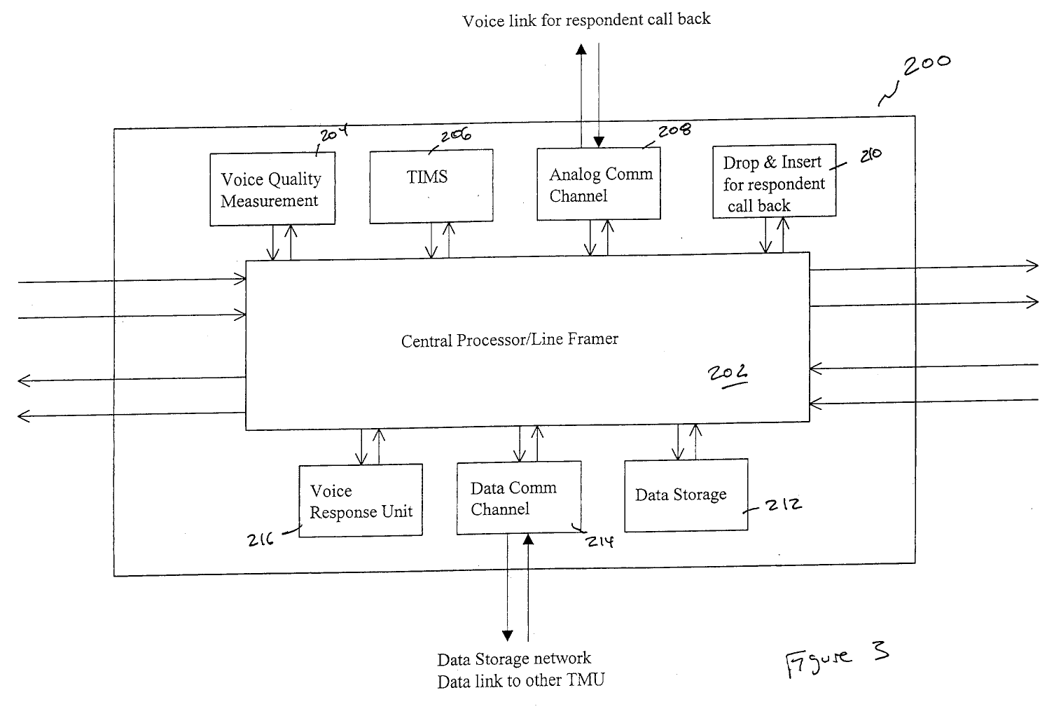

Test Monitor Units or TMUs 122 and 124 are shown in the figure. In the preferred embodiment, both the originating endpoint 102 and terminating endpoint 104 are associated with a TMU 122 and 124, respectively. It is noted, however, that in alternate embodiment, only one of the TMUs 122 or 124 might be present. For example, in some embodiments a single TMU could monitor and test both the origination and the end points. This solution, however, will incur long distance charges for any call back across the network. Further details on a specific example of a TMU are provided below with respect to FIG. 3.

The TMU 122 (124) monitors the output of calls to or from the PBX 114 (118). The TMU 122 is preferably interconnected to the SS7 network or to the SIP (session initiation protocol) network, so that they can monitor signaling that goes back and forth. As is known, the SS7 and SIP networks are signaling networks associated with the switched network 106 and Internet network 108, respectively. In the figure, the full line illustrates the actual circuit where your voice or your data will reside and the dash line shows the signaling network, which would either be SS7 or SIP. The signaling could also include other signaling types such channel associated signaling (CAS) or H232.

TMU 122 (124) can monitor any number of parameters. In the preferred embodiment, TMU 122 (124) uses existing technology to measure some or all of average voice level, loss, noise (e.g., Gaussian and/or impulse), echo, distortion, reflection, average speech power, delay, jitter and packet loss. Performing these measurements is known in the art and test equipment is readily available. TMU 122 (124) can also measure the call set up and tear down, where the call is at and what state the call is in.

As an example, if the TMU 122 (124) recognizes a disconnect initiation, it could intercept it possibly and at that point could go back to drop and insert into that time slot. In this manner the TMU 122 (124) could bridge on to the talker and/or the listener path and make inquiries related to the quality of the call that just ended. As but two examples, the TMU 122 (124) can inquire as to the quality of the call (e.g., “How did this call sound?”) or the echo (e.g., “How would you rate this call for echoes?”).

A number of methodologies could be used to select those calls that receive the quality monitor. In one instance, the TMU 122 (124) could choose a random selection of calls, for example one of a thousand (or whatever number makes sense). In another example, the TMU 122 (124) could select all calls that fall below a specific standard of measured objective criteria. For example, all call connections with a packet loss greater than five packets per minute or a signal level below about 15 dB. If networks are being compared, it is preferable that monitored calls be split somewhat evenly between the different networks. This information could be stored for later analysis or for use in meeting quality of service guarantees.

In the preferred embodiment, TMU 122 (124) is housed separately from the PBX 114 (118). This configuration is convenient in the sense that a test unit could be moved to various places on the network during different phases of evaluation. It is not necessary, however, to have the test unit as a separate unit. In fact, in embodiments of the present invention that use a TMU to monitor quality it may be convenient to integrate the test unit 122 (124) in the same housing as the PBX 114 (118) or in the gateway 110 or in other equipment not shown. For example, the test unit 122 (124) could be integrated into the customer's termination equipment (not shown). In most instances, the physical location of the test apparatus is not crucial.

In a typical configuration, TMU 122 (124) is coupled to the PBX 114 (118) through a DS1 or a T1 line. In the illustrated example, the TMU 122 (124) passes the T1 (DS1) line over to the class 3 switch 120, which is part of circuit-switched network 106. Another line, e.g., a TI line, will couple the test unit 122 (124) to the voice gateway 110. The TMU 122 (124) could be coupled through a LAN (local area network) connection as well of off that PBX. This connection could be Ethernet or another type of connection. Going into the voice gateway 110, the signal would pass the TMU 122 (124) so that the test unit could monitor not only the signaling sessions on SIP or SS7, but would also monitor the packets that go through there. Preferably, the test unit would have the ability to decode whatever voice encoding, e.g., 729, 711 or 723, is used.

In the preferred embodiment, the collected data is stored in a central database, indicated by server 126. The server 126 can also perform the analyses of the data and may serve as a communication path between the two TMUs 122 and 124. While server 126 is shown as a single device, it is noted that this functionality can be distributed among any number of physical devices, which are either local or remote to one another.

FIG. 2 provides a series of blocks that illustrate the procedure of a preferred embodiment. The preferred method of implementing the present invention will now be described with reference to FIG. 2, as well as FIG. 1.

In block 12, a call is initiated by a user. The user has preferably been notified in advance that some number of calls may be monitored for testing. For example, the user may be a service subscriber who has been offered a discount in exchange for providing evaluation information. In another example, the testing procedure can be used for calls within a particular organization, e.g., a service provider themselves. In other words, a service provider could utilize its own employees to monitor the quality of its network.

When the call is initiated, test unit 122 associated with the originator is initiated. This test unit 122 can be used to monitor objective characteristics of the call. At the same time, test unit 124 associated with the termination of the call can be initiated. For example, test unit 124 can be notified about the call by the originating PBX 114. Block 14 illustrates the initiation. In the preferred embodiment, test units are utilized at both ends of the call. In other embodiments, however, a single test unit may be used. In yet other embodiments, more that two test units are used, for example, at various nodes within the network.

In the preferred embodiment, the PBX 114 looks up a table of test sites to determine whether the destination is enabled to participate in the test. If so, then the test will begin utilizing both TMUs 122 and 124. In an alternate embodiment, only one of the TMUs 122 or 124 is used.

The call is then routed from the origination point to the termination point, as shown by block 16. This routing can be across the public telephone network or across a virtual private network. In case of comparison between alternative technologies (e.g., VoIP vs. circuit switched) the call can be randomly routed through alternative media, e.g., packet switched or circuit switched networks. The PBX 114 is the component that initiates the route. A statistical algorithm can be used to ensure that information about the differences between the two networks can be gathered by trying to randomize factors (e.g., time of day, location of participants, and others) other then the network.

Test units on one or both sides of the call can send a voice message to the calling parties, as noted by block 18. Block 18 represents an optional step. The procedure would work equally well if the subjective tester is the originator of the call or the receiver of the call. In the preferred embodiment, the subjective testing is done by both the originator and the receiver to find any asymmetries in the network. An example of a voice message could be: “This will be subject to quality test. After the call will be terminated, you will be called back [please stay on the line] to evaluate the call quality on 1 to 4 [3 or 5 (or other)] scale. At the end of evaluation you will be notified about network type used.” Obviously, other messages could be used.

In the preferred embodiment, the message is provided at the beginning of the phone conversation. This timing is not a requirement. The message could play during the call, e.g., when the TMU recognizes a questionable objective measurement. In other embodiments, no message is provided at all. In that case, the TMU could simply call back the user and explain the survey. In another embodiment, the user could know in advance to perform some action to initiate the survey.

As shown by block 20, the users will carry on their telephone conversation. This conversation is preferably a “real life” conversation in the sense that it would have occurred even if the absence of subjective testing. In an alternate embodiment, the conversation could be set up to occur for the purpose of the testing, or at least in part for the purpose of the testing. As an example, corporate employees may be asked to communicate by phone (rather than alternatives such as e-mail) whenever feasible to increase the number of samples. For the purposes here, this too would be considered a “real life” conversation.

Block 22 indicates that the user evaluates the call. This evaluation typically occurs after the conversation and is automatically initiated by the TMU. The initiation of the test can occur in a number of ways. In one embodiment, the user hangs up and is called by the TMU 122 (124). As discussed above, the TMU can accomplish this by intercepting the disconnect and inserting itself into the line. Alternatively, the user can provide some indication that the conversation has ended. For example, the user may press the pound (#) key (or whatever other key or combination of keys is used). The TMU will recognize this signal and begin the evaluation questioning.

The TMU can intervene in the call at the beginning of the call or after the call terminates or it could suspend the termination long enough to make that connection bring the parties back. Alternatively, the test units could let the call terminate and then each TMU 122, 124 would call back from each respective site to obtain the evaluation data. The TMUs 122 and 124 would then communicate to see whether responses are received by both TMUs. If not, the system can be configured to either keep the single sided information or to throw out the data.

During the evaluation phase, the user completes the subjective test by answering several questions on voice quality. In the preferred embodiment, the user uses the telephone buttons (e.g., DTMF tones) to answer the questions. The present invention would work equally well with voice recognition. While inefficient, the user could be asked to fill out a questionnaire and provide to the tester, either electronically or otherwise.

The test results together with general information can be sent to, stored and processed in computer 126 for statistical analysis, as shown by block 24. The general information can include things such as the type of technology used in the call (e.g., circuit or packet switched), the origination and destination points, the date and time of the call, weather conditions, language of the callers, and/or other information that could be useful in evaluating the network.

The server could be a static database or could be a real line database where the connection made at the network management center. This network management center could be network center for both the PSTN and the IP network, so the system can pull off congestion data for both networks,

Independently, objective data is preferably gathered. The objective data could include PBX trunk utilization, signal level, noise level, silence ratio, distortion, echo, delay and/or packet loss. This information can be used for statistical analysis together with quality data gathered as described above. For example, the subjective voice quality data can be correlated with objective factors, like network condition. An exemplary method of correlating quantitative measurements with subjective quality ratings is provided in co-pending U.S. patent application Ser. No. 09/220,733, filed Dec. 24, 1998 and incorporated herein by reference.

The test described here can be used in a variety of voice quality studies. For example, as noted above, the voice quality of a packet switched network can be compared with a circuit switched network. Another example is a study of the perception of voice quality by both calling parties. In another study, voice quality can be analyzed as a function of things such as origination/destination, network congestion, time of day, day of week, gateway parameters (for VoIP), and combinations of some or all of the above as well as other factors. In another aspect, call completion statistics could be compiled. Other tests are also envisioned and within the scope of this invention.

The information received could also be used to monitor and enhance the quality of the network. For example, if a particular call receives low ratings, then the test data can be analyzed and the network management system can be notified to open a trouble ticket. The trouble ticket could cause the call detail records to be pulled and a record to start being built. If a number of calls that go over the same route are bad, then the problem can be identified and hopefully resolved.

An example can be used to illustrate an application of monitoring and improving a communications system. In this example, it is determined that a number of problems have been noted on calls routed over a packet-switched portion of the network. Routing information can be retrieved from the gateways to determine how the packets were routed. The system can look for common denominators. It can be determined if the network was in a congestion mode or had a failure. If so, these problems are accounted. If not, the network management database can be consulted to check for current alarms. All of these events, e.g., network objective measurements, traffic flow, alarms, and others, can be correlated.

If there are no current alarms, then maybe there is nothing wrong with the system and the problems were caused by an anomaly. The system can just keep monitoring. If the problems continue, a trouble ticket can be opened. If there is an alarm present, then the system can assume that efforts are already being taken to correct the problem.

In another embodiment, the communications provider can offer a service where the user can indicate to the system that a bad connection is being encountered. For example, the user could use the telephone keys to provide a specific message that is received by the communications network, e.g., by a test monitor unit. The receipt of a problem indication from the user could trigger the TMU to start taking the measurements. In this manner, the user could proactively report something. Trouble tickets could be automatically generated, based upon the indication from the user.

This system provides an advantage over the case where the user hangs up and calls the operator in that the connection is still active. Tests that are not routinely performed can be taken to help analyze the problem. In one embodiment, the TMU can question the user as to the type of problems and the tests performed could be based upon the response. With this capability, the service provider could advertise automatic troubleshooting.

In a system where the user can initiate trouble shooting, it may be preferable to include measures to avoid abuse. For example, if one particular user continually indicates that problems are occurring, when in fact none are, then the system could block that user from requesting a trouble shoot.

In another embodiment, the indication from the user could give a redirect to a call center. Rather than, or in addition to, performing the diagnosis automatically, the user can be connected to an operator. It is advantageous that the system can keep the link together to do testing while the trouble-shooting is done right on the line. In this manner, the network management center and trouble tickets could be linked into your call center.

As another variation, the user indication could cause the call to be redirected. In this embodiment, a user determines that the quality of a telephone is low and presses some key or sequence of keys. The system could then automatically redirect the call along another circuit. At the same time, the original circuit can be maintained and tested. This could greatly facilitate troubleshooting. Certain problems are particularly difficult to diagnose and this system could be helpful.

As an example, assume that an intermittent problem exists. For instance, a faulty matrix card is causing only one way audio to go through one channel. That one channel could service the entirety of the switch. In other words, it could be anywhere on 100,000 ports on that switch depending on how your matrix is configured. As a result, the problem could float across any connection that could possibly go through that switch. To isolate the problem, the call exhibiting the problem could be held to see where the particular circuit is going through the maintenance. This would be difficult if the service provider doesn't learn of the problem until after the call is completed, if ever at all.

FIG. 3 illustrates a block diagram of a preferred embodiment test monitor unit 200. This discussion provides one example of a test unit that could be used for TMUs 122 and/or 124. Other examples, consistent with the descriptions herein, are possible.

Test unit 200 includes a central processor and line framer 202. The unit performs the function of interfacing the bearer channel and or signaling channel and interpreting channel status. In the preferred embodiment, processor 202 is implemented with a microprocessor.

A number of units are included in the test unit 200. These units are illustrated as blocks in communication with the processor. This illustration is provided to indicate that each of the functions are performed and provide information to the processor 202. These blocks can be implemented as separate hardware circuits, e.g., separate chips or boards or separate circuits on the same chip. Alternatively, these functions could be implemented by software (or a state machine) operating on processor 202. The particular choice can vary from block to block or even within a block.

Each of the blocks will now be described.

Block 202, Central Processor/Line Framer, provides bearer line termination or access, control functions to allow applications to the test and measurement capability, and access to signaling where applicable. Additionally this device can be used to measure and track any error performance of the bearer channels such as bit errors, packet loss, error seconds, jitter etc.

Block 204, Voice Quality Measurement, allows for the measurement of attributes of the call connection such as voice speech level, echo return loss, echo return loss delay, and noise.

Block 206, Transmission Impairment Measurement Set (TIMS), provides for the ability to generate and measure the call connections for various attributes such as volume, noise, and echo return loss.

Block 208, Analog Communications Channel, allows for respondent call back features outside the monitored call connections to collection of subscriber opinion of the call connection.

Block 210, Drop & Insert, allows for the TMU to access the bearer channel for the collection of respondent information. The Drop & Insert allows for the TMU to insert itself into the bearer channel of a call connection and interrogate the respondents without having to initiate a separate call back.

Block 212, Data Storage, this unit allows for the storage of respondent data as well as objective test measurements from either the voice quality measurement device (block 204) the TIMS unit (block 206), the Drop & Insert (block 210), and/or the voice response unit (block 216). The data stored can be either sent to a central repository for long-term storage or to a data processing application for manipulation.

Block 214, Data Communication Channel, provides for communication of the TMU to a controller for the configuration of control parameters for selection of testing and connection monitoring. Also the Data Communication Channel can be used for the delivery of data from the data storage device to a data repository or manipulation application.

Block 216, Voice Response Unit, provides for the interrogation of the respondents on a call connection through an interactive voice menu. This menu could be either voice or DTMF compelled. The VRU con be directed to the respondents through either the analog Communications Channel (Block 208) or through the Drop & Insert function (block 210).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of monitoring quality of a communication system, the method comprising:
receiving an indication that a first telephone user wishes to conduct a telephone conversation with a second telephone user;
connecting the first telephone user with the second telephone user so that the telephone conversation can be conducted; and
upon completion of the telephone conversation, automatically conducting a quality survey with at least one of the first telephone user and the second telephone user.

2. The method of claim 1 and further comprising initiating a test unit upon receiving the indication that the first telephone user wishes to conduct a telephone conversation with a second telephone user.

3. The method of claim 2 wherein initiating a test unit comprises initiating a first test unit associated with the first telephone user and initiating a second test unit associated with the second telephone user.

4. The method of claim 1 and further comprising providing a message to the at least one of the first telephone user and the second telephone user, the message informing the at least one of the first telephone user and the second telephone user that the quality survey will be conducted upon completion of the telephone conversation.

5. The method of claim 1 and further comprising performing objective measurements of a connection between the first telephone user and the second telephone user, the connection being made during the telephone conversation.

6. The method of claim 5 wherein the objective measurements are selected from the group consisting of average voice level, signal, level, loss, noise, echo, distortion, reflection, average speech power, delay, jitter, packet loss, and combinations thereof.

7. The method of claim 1 wherein connecting the first telephone user with the second telephone user comprises routing the telephone conversation across a packet-switched network.

8. The method of claim 1 wherein connecting the first telephone user with the second telephone user comprises routing the telephone conversation across a circuit-switched network.

9. The method of claim 1 wherein the quality survey is conducted with use of the telephone keypad on a telephone of the at least one of the first telephone user and the second telephone user.

10. The method of claim 1 wherein the quality survey is conducted with use of voice recognition technology.

11. The method of claim 1 and further comprising storing results of the quality survey in a database.

12. The method of claim 11 and further comprising analyzing the results to compare a quality level of a first network portion to a quality level of a second network portion.

13. The method of claim II and further comprising analyzing the results to correlate the results with objective measurements taken during the telephone conversation.

14. The method of claim 1 wherein the quality survey is initiated by a test unit that calls back the at least one of the first telephone user and the second telephone user.

15. A method of monitoring the quality of a communication system, the method comprising:
receiving an indication that a first telephone user wishes to conduct a telephone conversation with a second telephone user;
connecting the first telephone user with the second telephone user so that the telephone conversation can be conducted;
during the telephone conversation, receiving an indication from a telephone user that a bad connection is being encountered, the telephone user being one of the first or the second telephone users; and
responding to the indication that a bad connection is being encountered.

16. The method of claim 15 wherein responding comprises connecting the user to an operator.

17. The method of claim 15 wherein responding comprises performing measurements on a network that is carrying the telephone conversation.

18. The method of claim 15 wherein responding comprises conducting a survey with the telephone user, the survey including questions asked without human intervention.

19. The method of claim 18 wherein responding further comprises performing measurements on a network that is carrying the telephone conversation, the measurements being based at least in part on a response related to survey.

20. The method of claim 15 wherein responding comprises switching the telephone conversation to another route between the first telephone user and the second telephone user.

21. The method of claim 20 wherein responding further comprises:
keeping an original circuit active, the original circuit having been used to connect the first telephone user to the second telephone user prior to receiving the indication of a bad connection; and
analyzing the original circuit to determine a cause of the bad connection.

22. The method of claim 15 wherein responding comprises automatically generating a trouble ticket.

23. A telecommunications system that includes a quality monitoring capability, the system comprising:
a network capable of carrying communications from a first telephone to a second telephone;
a test unit coupled to the first telephone and to the network, the test unit configured to monitor telephone conversations over the network and to automatically initiate a quality survey with a user of the first telephone; and
a computer device coupled to the test unit, the computer device to store information gathered by the test unit.

24. The system of claim 23 and further comprising a second test unit coupled to the second telephone unit and to the network.

25. The system of claim 23 wherein the test unit is also coupled to the second telephone.

26. The system of claim 23 wherein the network comprises a circuit-switched network.

27. The system of claim 23 wherein the network comprises a packet-switched network.

28. The system of claim 23 wherein the first telephone is coupled to the network through a PBX.

29. The system of claim 23 wherein the network further comprises the first telephone and the second telephone.

30. The system of claim 23 wherein the test unit comprises:
a central processor;
a voice quality measurement unit coupled to the central processor; and
a voice response unit coupled to the central processor.

31. The system of claim 30 wherein the test unit further comprises a drop and insert unit coupled to the central processor.

32. The system of claim 30 wherein the test unit further includes a data storage unit coupled to the central processor.
